(19) United States
(12) Patent Application Publication
(10) Pub. No.: US 2006/0115091 A1
(43) Pub. Date: Jun. 1, 2006

(54) Apparatus and method of processing multi-channel audio input signals to produce at least two channel output signals therefrom, and computer readable medium containing executable code to perform the method

(76) Inventors: Sun-min Kim, Suwon-si (KR); Byeong-Seob Ko, Suwon-si (KR)

Correspondence Address: STANZIONE & KIM, LLP, 919 18TH STREET, N.W., SUITE 440, WASHINGTON, DC, 20006, US

(21) Appl. No.: 11/284,185

(22) Filed: Nov. 22, 2005

Related U.S. Application Data
(60) Provisional application No. 60/630,810, filed on Nov. 26, 2004.

(30) Foreign Application Priority Data
Feb. 4, 2005 (KR) 2005-10755

(51) Int. Cl. H04R 5/00; H04R 5/02

(52) U.S. Cl. 381/18; 381/310; 381/17

(57) ABSTRACT

An apparatus to process m-channel audio input signals to produce n channel output signals, and n is less than m. This apparatus includes a first filter unit to reduce a correlation between at least two channel audio input signals among the m-channel audio input signals, a virtual sound source generation unit to transform the at least two channel audio input signals output from the first filter unit into virtual sound sources at predetermined positions around a listener position, and an output controller to control channel audio input signals other than the at least two channel audio input signals among the m-channel audio input signals based on gains and delays of the at least two channel audio input signal output from the virtual sound source generation unit. Even when the m-channel audio input signals are reproduced through 2 channels, a surround effect provided by an m-channel speaker system can be obtained. In addition, a localization of a sound is improved, and a presence is formed. Thus, an enhanced surround sound is provided to a listener.

### CROSS-REFERENCE TO RELATED APPLICATIONS

This application claims the benefit of Korean Patent Application No. 2005-10755, filed on Feb. 4, 2005 in the Korean Intellectual Property Office, and U.S. Provisional Patent Application No. 60/630,810, filed on Nov. 26, 2004 in the U.S. Patent and Trademark Office, the disclosures of which are incorporated herein in their entirety by reference.

### BACKGROUND OF THE INVENTION

1. Field of the Invention

The present general inventive concept relates to a method of reproducing an input 5.1 channel sound (or another multi-channel group) through a 2 channel speaker system. More particularly, the present general inventive concept relates to audio post-processing technology in which input left and right surround channel sounds form a sound image at a left rear and a right of a listener position while input left, center, low frequency effect (LFE), and right channel sounds form a natural surround sound by correcting an output gain and a delay thereof.

2. Description of the Related Art

A conventional virtual speaker device that uses down-mixing technology is disclosed in WO99/49574. FIG. 1 is a block diagram illustrating the conventional virtual speaker device.

The conventional virtual speaker device of FIG. 1 can make a 6-channel surround effect through a 2-channel speaker. The conventional virtual speaker device is comprised of an impulse response for each channel obtained from a head related transfer function (HRTF), a convolution unit for convolving an input signal with an impulse response for each channel, and an adding unit for adding the convolved signals to produce two channels (i.e., a left channel and a right channel).

More specifically, the conventional virtual speaker device of FIG. 1 convolves audio input signals of a left front channel, a right front channel, a center front channel, a left surround channel, a right surround channel, and a low frequency effect (LFE) channel with corresponding impulse responses to produce two signals, namely, left and right signals for each channel (i.e., the left and right channels). Right signals for the 6 channels are added together, and left signals for the 6 channels are added together, thereby producing two channel output signals, namely, a left channel signal and a right channel signal.

When the two channel output signals are reproduced, a surround effect is produced such that a left virtual speaker, a right virtual speaker, a center virtual speaker, a left-surround virtual speaker, and a right surround virtual speaker seem to be placed around a listener.

However, when a correlation between the left surround channel and the right surround channel is high, the conventional virtual speaker device of FIG. 1 has difficulty in forming a sound image at a rear of the listener.

A high correlation between two channels indicates that the two channels have almost the same sound characteristics. A description of why it is difficult to form the sound image at the rear of the listener when the correlation is high is as follows.

A virtual sound source is formed using an HRTF, which is a characteristic of an acoustic signal at the ears of a human depending on shapes of the head and ears of the human. The HRTF can perceive a 3-dimensional audio sound, because of a phenomenon where paths of the acoustic signals differ. The paths include a simple path difference resulting from an inter-aural level difference (ILD) or an inter-aural time difference (ITD). In addition, a complicated path difference resulting from a changing direction of the acoustic signals due to a diffraction at a surface of the head of the human (i.e., a listener), a reflection by an auricle of the human, or the like. Since the HRTF in each of the horizontal and vertical directions has unique characteristics, the 3-dimensonal audio sound can be produced using the HRTF.

The HRTF can easily distinguish between a left side and a right side on a horizontal plane. However, an error of the HRTF makes it difficult to distinguish between a front position and a rear position on the horizontal plane. In order to distinguish between the front position and the rear position, accurate frequency characteristics of an actual user should be measured. However, if a standard dummy head is used to measure frequency characteristics, front/back confusion occurs due to a difference between frequency characteristics of the standard dummy head and the actual human listener.

In order to create a surround channel effect, surround channels must form sound images at a left rear and a right rear of the listener. However, when a correlation between left and right surround channel audio input signals is high, the sound image is formed at a center rear of the listener instead of at the left and right rears of the listener. In addition, due to the use of the standard dummy head, front/back confusion occurs. Thus, it is difficult to obtain the surround channel effect.

### SUMMARY OF THE INVENTION

The present general inventive concept provides an apparatus and method of reproducing m-channel audio input signals using an n-channel speaker system, n being less than m, in which a surround effect obtained by an m-channel speaker system can be obtained even when the n-channel speaker system includes two (or more) speakers. Additionally, surround channel audio input signals are transformed into virtual speakers at a left rear and a right rear of a listener position so that the listener can perceive a surround effect.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an apparatus to process m-channel audio input signals to produce n channel output signals, n being less than m, the apparatus including a first filter unit to reduce a correlation between at least two channel audio input signals among the m-channel audio input signals, a virtual sound source generation unit to transform the at least two channel audio input signals output by the first filter unit into virtual sound sources at predetermined positions around a listener position, and an output controller to control gains and delays of channel audio input signals other than the at least two channel audio input signals among the multi-channel audio input signals based on gains and delays of the at least two channel audio input signals output from the virtual sound source generation unit.

The foregoing and/or other aspects of the present general inventive concept are also achieved by providing an apparatus to process m-channel audio input signals to produce n-channel output signals, n being less than m, the apparatus including a first filter unit to group delay a specific frequency component of at least two channel audio input signals among the m-channel audio input signals, a virtual sound source generation unit to transform the at least two channel audio input signals output from the first filter unit into virtual sound sources at predetermined positions around a listener position, and an output controller to control gains and delays of channel audio input signals other than the at least two channel audio input signals among the multi-channel audio input signals based on gains and delays of the at least two channel audio input signal output by the virtual sound source generation unit.

The foregoing and/or other aspects of the present general inventive concept are also achieved by providing a method of processing multi-channel audio input signals to produce n-channel output signals, n being less than m, the method including reducing a correlation between at least two channel audio input signals among the m-channel audio input signals, transforming the at least two channel audio input signals into virtual sound sources at predetermined positions around a listener position, and controlling gains and delays of channel audio input signals other than the at least two channel audio input signals among the multi-channel audio input signals based on gains and delays of the at least two channel audio input signal transformed into the virtual sound sources.

The foregoing and/or other aspects of the present general inventive concept are also achieved by providing a method of processing m-channel audio input signals to produce n-channel output signals, n being less than m, the method including group-delaying a specific frequency component of at least two channel audio input signals among the multi-channel audio input signals, transforming the at least two channel audio input signals into virtual sound sources at predetermined positions around a listener position, and controlling gains and delays of channel audio input signals other than the at least two channel audio input signals among the multi-channel audio input signals based on gains and delays of the at least two channel audio input signals transformed into the virtual sound sources.

The foregoing and/or other aspects of the present general inventive concept are also achieved by providing a computer-readable medium containing executable code to perform the methods described above.

The foregoing and/or other aspects of the present general inventive concept are also achieved by providing an apparatus to produce surround sound with a plurality of channel signals in a system having a predetermined number of speakers, the predetermined number of speakers being less than a number of the plurality of channel signals, the apparatus comprising a filter process unit to receive at least first and second channel signals of the plurality of channel signals having similar signal characteristics and to process the first and second channel signals differently such that the signal characteristics of the first and second channel signals are made different from each other, and a virtual sound unit to produce at least first and second virtual sound sources at predetermined positions within a sound field from the first and second channel signals having the different signal characteristics.

The foregoing and/or other aspects of the present general inventive concept are also achieved by providing an apparatus to process n channel signals to produce a surround sound effect in a speaker system having m speakers, m being less than n, the apparatus comprising a filter unit to induce different delays in at least two of the n channel signals, and a virtual sound unit to receive the delayed at least two of the n channel signals and to localize the received at least two of the n channel signals at predetermined positions around a listener position, and an output controller to control gains and delays of the n channel signals other than the at least two of the n channel signals according to gains and delays of the at least two of the n channel signals.

The foregoing and/or other aspects of the present general inventive concept are also achieved by providing a method of producing surround sound with a plurality of channel signals in a system having a predetermined number of speakers, the predetermined number of speakers being less than a number of the plurality of channel signals, the method comprising receiving at least first and second channel signals of the plurality of channel signals having similar signal characteristics, processing the first and second channel signals differently such that the signal characteristics of the first and second channel signals are made different from each other, and producing at least first and second virtual sound sources at predetermined positions within a sound field from the first and second channel signals having the different signal characteristics.

The foregoing and/or other aspects of the present general inventive concept are also achieved by providing a method of processing n channel signals to produce a surround sound effect in a speaker system having m speakers, m being less than n, the method comprising inducing different delays in at least two of the n channel signals, localizing the delayed at least two of the n channel signals at predetermined positions around a listener position, and controlling gains and delays of the n channel signals other than the at least two of the n channel signals according to gains and delays of the at least two of the n channel signals.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a schematic configuration illustrating a conventional virtual speaker device based that uses a down-mixing technique;

FIG. 2 is a schematic configuration illustrating an apparatus to process multi-channel audio input signals to produce two channel output signals according to an embodiment of the present general inventive concept;

FIG. 3 is a block diagram illustrating a virtual surround filter according to an embodiment of the present general inventive concept;

FIG. 4 is a block diagram illustrating a first filter unit according to an embodiment of the present general inventive concept;

FIG. 5 is a block diagram illustrating a first filter unit according to another embodiment of the present general inventive concept;

FIG. 6 is a configuration illustrating a virtual sound source generation unit according to an embodiment of the present general inventive concept;

FIG. 7 is a block diagram illustrating a calculation of the virtual sound source generation unit of FIG. 6;

FIG. 8 is a block diagram illustrating an output controller according to an embodiment of the present general inventive concept;

FIG. 9 is a flowchart illustrating a method of processing multi-channel audio input signals to produce two channel output signals;

FIG. 10 is a flowchart illustrating a method of reducing a correlation between a left surround channel audio input signal and a right surround channel audio input signal according to an embodiment of the present general inventive concept;

FIGS. 11A and 11B are flowcharts illustrating methods of group-delaying specific frequency components of left and right surround channel audio input signals, respectively, according to another embodiment of the present general inventive concept;

FIG. 12 is a flowchart illustrating a method of transforming left and right surround channel audio input signals into virtual sound sources; and

FIG. 13 is a flowchart illustrating a method of controlling channel audio input signals other than left and right surround channel audio input signals.

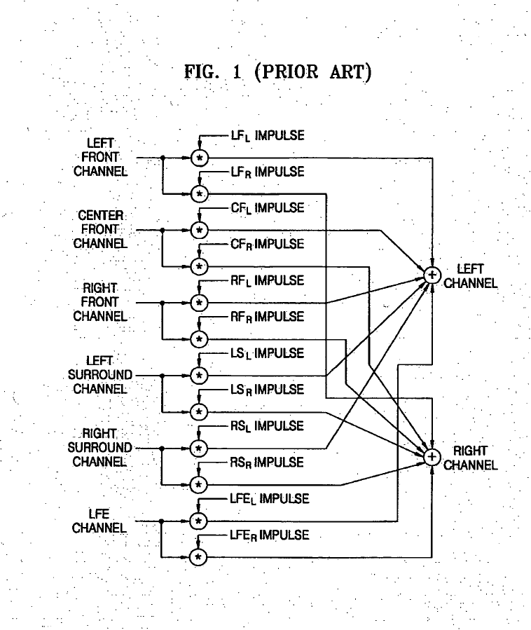

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

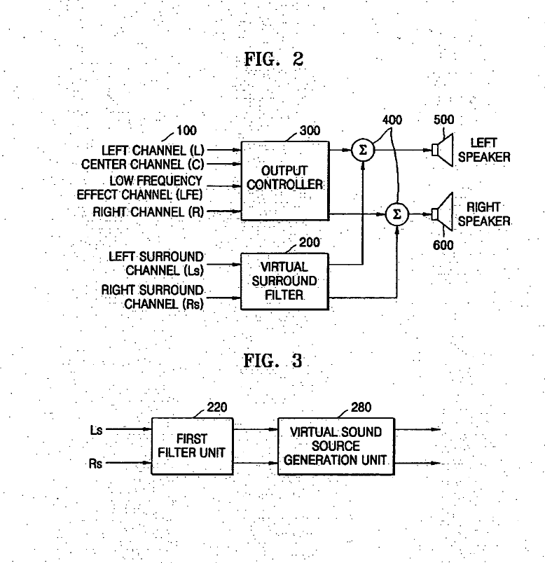

FIG. 2 is a schematic configuration illustrating an apparatus to process multi-channel audio input signals 100 to produce two channel output signals. The apparatus of FIG. 2 includes a virtual surround filter 200, an output controller 300, adders 400, a left channel speaker 500, and a right channel speaker 600.

The multi-channel audio input signals 100 comprise a left channel L, a center channel C, a low frequency effect channel LFE, a right channel R, a left surround channel Ls, and a right surround channel Rs. Although a group of 5.1 channels is described and illustrated in this embodiment, it should be understood that other multi-channel groups, such as a group of 6.1 channels or a group of 7.1 channels, may alternatively be used.

The virtual surround filter 200 receives the left surround channel Ls and the right surround channel Rs from among the multi-channel audio input signals 100.

The virtual surround filter 200 reduces a correlation between the left and right surround channels Ls and Rs and produces virtual sound sources at a left rear and a right rear of a listener position. The operations of the virtual surround filter 200 are described below in greater detail with reference to FIGS. 3 through 7.

The output controller 300 receives the left channel L, the center channel C, the low frequency effect channel LFE, and the right channel R from among the multi-channel audio input signals 100.

The virtual sound filter 200 changes frequency characteristics of the left and right surround channels Ls and Rs to produce the virtual sound sources. The output controller 300 controls output gains and time delays of the left channel L, the center channel C, the low frequency effect channel LFE, and the right channel R.

One of the adders 400 adds up left signals of the channel audio input signals 100 output by the virtual surround filter 200 and the output controller 300 and outputs the added left signals to the left channel speaker 500. The other adder 400 adds up right signals of the channel audio input signals 100 output by the virtual surround filter 200 and the output controller 300 and outputs the added right signals to the right channel speaker 600.

If a 6.1-channel audio input signal used instead of the 5.1 channel audio input signal, a rear surround channel is used with the 5.1 channels. In this case, a virtual surround filter which is the same as the virtual surround filter 200 is further included and receives two signals into which the corresponding rear surround channel audio input signal is divided.

If a 7.1-channel audio input signal is received instead of the 5.1 channel audio input signal, two rear surround channels are used with the 5.1 channels. In this case, a virtual surround filter which is the same as the virtual surround filter 200 is further included and receives the corresponding two rear surround channel audio input signals.

FIG. 3 is a block diagram illustrating the virtual surround filter 200 (see FIG. 2) according to an embodiment of the present general inventive concept. The virtual surround filter of FIG. 3 includes a first filter unit 220 and a virtual sound source generation unit 280.

The first filter unit 220 reduces a correlation between the left and right surround channel audio input signals Ls and Rs to improve a localization of a surround channel sound and simultaneously form a presence. When the first filter unit 220 is not used and the correlation between the left and right surround channel audio input signals Ls and Rs is high, a sound image is formed as a phantom image at a center rear of the listener position instead of at the left and right rears of the listener position. The sound image at the center rear of the listener position may be heard at a front of the listener position due to front/back confusion, which makes it difficult for the listener to perceive a surround effect.

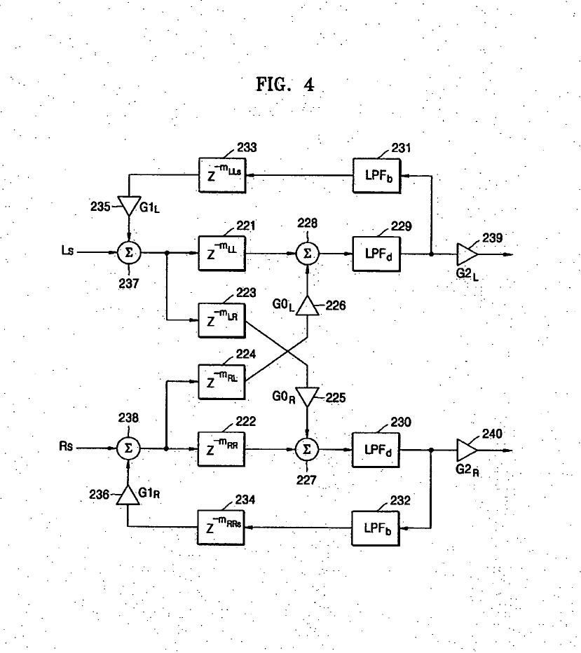

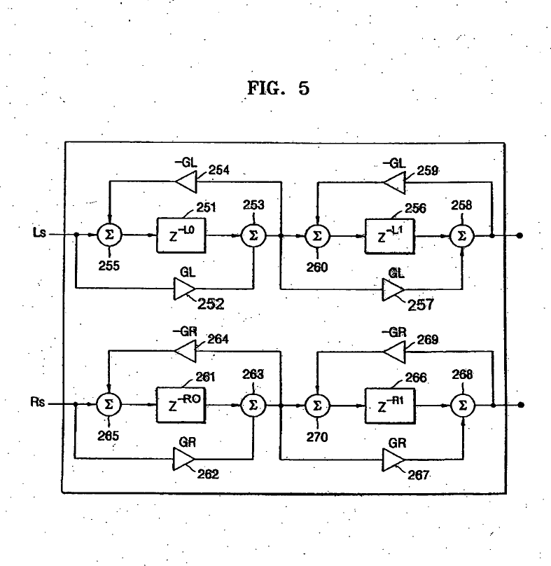

Thus, the first filter unit 220 reduces a sound correlation between the left and right surround channel sound signals Ls and Rs and forms a presence, to thereby produce a natural surround channel effect. A configuration of the first filter unit 220 is described below with reference to FIGS. 4 and 5.

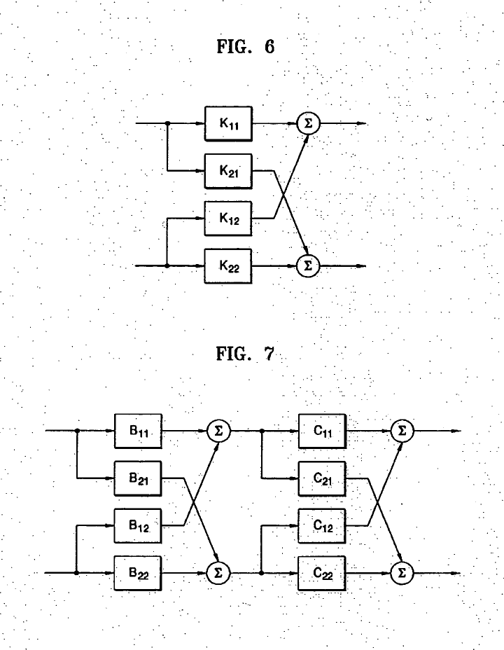

The virtual sound source generation unit 280 receives signals output by the first filter unit 220 and forms the virtual sound sources at the left and right rears of the listener position to produce the surround effect. A configuration of the virtual sound source generation unit 280 is described below with reference to FIGS. 6 and 7.

FIG. 4 is a block diagram illustrating a configuration of the first filter unit 220 (see FIG. 3) according to an embodiment of the present general inventive concept. The first filter unit 220 is implemented with a plurality of delay units which can be asymmetrical, a plurality of gain units, and a plurality of adders.

The first filter unit 220 includes a first delay unit 221, a second delay unit 222, a third delay unit 223, a fourth delay unit 224, a first gain unit 225, a second gain unit 226, a first adder 228, a second adder 227, a first filter 229, a second filter 230, a third filter 231, a fourth filter 232, a fifth delay unit 233, a sixth delay unit 234, a third gain unit 235, a fourth gain unit 236, a third adder 237, and a fourth adder 238.

The first delay unit 221 delays the left surround channel sound signal Ls for a first predetermined period of time. In the present embodiment, the first delay unit 221 is a delay filter having a transfer function of Z^{-m}_{LL}.

The second delay unit 222 delays the right surround channel sound signal Rs for a second predetermined period of time. In the present embodiment, the second delay unit 222 is a delay filter having a transfer function of Z^{-m}_{RR}.

The first and second delay units 221 and 222 are asymmetrical. In other words, the first and second delay units 221 and 222 delay received signals (i.e., the left surround channel signal Ls and the right surround channel signal Rs) for different periods of time (i.e., the first and second predetermined periods of time).

The third delay unit 223 delays the left surround channel sound signal Ls for a third predetermined period of time. In the present embodiment, the third delay unit 223 is a delay filter having a transfer function of Z^{-m}_{LR}.

The fourth delay unit 224 delays the right surround channel sound signal Rs for a fourth predetermined period of time. In the present embodiment, the fourth delay unit 224 is a delay filter having a transfer function of Z^{-m}_{RL}.

The third and fourth delay units 223 and 224 are also asymmetrical. In other words, the third and fourth delay units 223 and 224 delay received signals (i.e., the left surround channel signal Ls and the right surround channel signal Rs) for different periods of time (i.e., the third and fourth predetermined periods of time).

The first gain unit 225 changes an output gain of the third delay unit 223, and the second gain unit 226 changes a gain of the fourth delay unit 224.

The first adder 228 adds an output of the first delay unit 221 and an output of the second gain unit 226. The second adder 227 adds an output of the second delay unit 222 and an output of the first gain unit 225.

The first and second gain units 225 and 226 reduce output gains of the left and right surround channel audio input signals Ls and Rs delayed for the predetermined periods of time by the third and fourth delay units 223 and 224, respectively. The first and second gain units 225 and 226 prevent the two surround channel audio input signals from being mixed.

The first filter 229 filters an output signal of the first adder 227, and the second filter 230 filters an output signal of the second adder 228. Output signals of the first and second filters 229 and 230 are applied to the virtual sound source generation unit 280.

The fifth delay unit 233 delays a signal that passes through the first and third filters 229 and 231 for a fifth predetermined period of time. In the present embodiment, the fifth delay unit 233 is a delay filter having a transfer function of Z^{-m}_{LLS}.

The sixth delay unit 234 delays a signal that passes through the second and fourth filters 230 and 232 for a sixth predetermined period of time. In the present embodiment, the sixth delay unit 234 is a delay filter having a transfer function of Z^{-m}_{RRS}. The fifth and sixth delay units 233 and 234 are asymmetrical. In other words, the fifth and sixth delay units 233 and 234 delay received signals for different periods of time (i.e., the fifth and sixth predetermined periods of time). The transfer functions of the delay units 233, 221, 223, 224, 222, and 234 may be selected according to design specifications.

The first, second, third, and fourth filters 229, 230, 231, and 232 may be low pass filters (LPFs) to filter out a high-band component of a received signal.

The third gain unit 235 changes an output gain of the fifth delay unit 233, and the fourth gain unit 236 changes an output gain of the sixth delay unit 234.

The third adder 237 adds an output signal of the third gain unit 235 and the left surround channel audio input signal Ls. The fourth adder 238 adds an output signal of the fourth gain unit 236 and the right surround channel audio input signal Rs.

FIG. 5 is a block diagram illustrating the first filter unit 220 (see FIG. 3) according to another embodiment of the present general inventive concept. The first filter unit of FIG. 5 has similar characteristics as those of the first filter unit of FIG. 4. However, the first filter unit of FIG. 5 can obtain a more natural presence than the first filter unit of FIG. 4 by using a full band filter applied to an artificial reverberator to artificially create reverberation characteristics of a space. A full band filter has a characteristic of group-delaying a specific frequency component. Due to the application of this characteristic of the full band filter, a mono signal can become a similar stereo signal.

The first filter unit of FIG. 5 is arranged so that two full band filters are dependently connected to each of the left and right surround channels Ls and Rs.

The left channel surround audio input signal Ls is input to a first full band filter (Z^{-L0}) 251. A gain of the left channel surround audio input signal Ls is changed while passing through a gain unit (GL) 252. Signals output by the gain unit (GL) 252 and the first full band filter (Z^{-L0}) 251 are added together by an adder 253. A gain of a signal output by the adder 253 is changed while passing through a gain unit (−GL) 254. A signal output by the gain unit (−GL) 254 and the left channel surround audio input signal Ls are then added together by an adder 255.

The signal output by the adder 253 is input to a second full band filter (Z^{-L1}) 256. Again of the signal output by the adder 253 is changed while passing through a gain unit (GL) 257. Signals output by the gain unit (GL) 257 and the second full band filter (Z^{-L1}) 256 are added together by an adder 258. A gain of a signal output by the adder 258 is changed while passing through a gain unit (−GL) 259. A signal output by the gain unit (−GL) 259 and the signal output by the adder 253 are added together by an adder 260.

Two full band filters dependently connected to the right surround channel, namely, a third full band filter (Z^{-R0}) 261 and a fourth full band filter (Z^{-R1}) 266, are arranged in a similar manner to the first and second full band filters 251 and 256 connected to the left surround channel. Operations of adders 263, 265, 268, and 270 may be similar to the adders 253, 255, 258, and 260, and operations of gain units (GR) 262 and 267 and (−GR) 264 and 269 may be similar to the gain units (GL) 252 and 257 and (−GL) 254 and 259, respectively.

When a mono signal is received, delay values of the four full band filters are set to be different as given by: L0≠L1≠R0≠R1, to convert the mono signal into a stereo signal. In order to maximize the reduction of the correlation due to the asymmetrical configuration of the first filter unit of FIG. 5, delay values of the two full band filters independently connected to each channel have a relationship of L0>L1 and R0>R1 or a relationship of L0<L1 and R0<R1.

Gain units of each all pass filter typically have identical values, but in some cases, may have different values. In order to prevent the signals from being out-of-phase, the gain units GL and GR may have identical or different signs, but the gain units 254 and 259 should have identical gain, the gain units 252 and 257 should have identical gain, the gain units 264 and 269 should have identical gain, and the gain units 262 and 267 should have identical gain.

FIG. 6 is a configuration of the virtual sound source generation unit 280 (see FIG. 3) according to an embodiment of the present general inventive concept. The virtual sound source generation unit of FIG. 6 transforms the left and right surround channel audio input signals Ls and Rs output by the first filter unit of FIG. 4 and/or 5 into virtual sound sources at the left rear and the right rear of the listener position.

The virtual sound source generation unit is arranged to receive the left and right surround channel audio input signals Ls and Rs output by the first filter unit, to convolve the left and right surround channel audio input signals Ls and Rs with four finite impulse response (FIR) filters K11, K12, K21, and K22, and to add the results of the convolutions together.

The left and right surround channel audio input signals Ls and Rs are convolved with the FIR filters K11 and K12, respectively, and two signals produced by these convolutions are added together to produce a left channel output signal. The left and right surround channel audio input signals Ls and Rs are convolved with the FIR filters K21 and K22, respectively, and two signals produced by these convolutions are added together to produce a right channel output signal.

The left and right channel output signals are added to the output signals of the output controller 300 (see FIG. 2) to produce final output signals of two channels.

FIG. 7 is a block diagram illustrating a calculation of the virtual sound source generation unit 280 (see FIG. 3).

The virtual sound source generation unit of FIG. 7 uses a binaural synthesis filter (B₁₁, B₁₂, B₂₁, and B₂₂), which is implemented as a first matrix of head related transfer functions (HRTFs) between a virtual sound source (i.e., a location thereof) and a virtual listener at the listener position, and a crosstalk cancellation filter (C₁₁, C₁₂, C₂₁, and C₂₂), which is implemented as an inverse matrix of a second matrix of HRTFs between the virtual listener and each location of 2 channel outputs. The locations of the 2 channel outputs correspond to locations of 2 speakers.

The binaural synthesis filter (B₁₁, B₁₂, B₂₁, and B₂₂) is implemented using the HRTFs, each of which is an acoustic transfer function between a sound source and an eardrum.

The HRTF contains various information representing characteristics of a space where a sound is transferred, including a timing difference between right and left ears of the listener, a level difference between the right and left ears of the listener, and shapes of right and left pinnas of the listener. Particularly, the HRTF includes information about the pinnas that critically affects localizations of upper and lower sound images. The information about the pinnas is usually obtained through measurements based on a dummy head, because modeling the pinnas having complicated shapes is difficult. A surround speaker is generally located between 90° and 110° with respect to a front center of the listener position. Hence, to localize a virtual speaker between 90° and 110° where the surround speaker is located, an HRTF is measured between 90° and 110° on each of the left and right sides from the front center of the listener position (e.g., by using the dummy head). The present general inventive concept is not limited thereto. The HRTF may be measured between 80 and 130 degrees.

HRTFs between a speaker located between 90° and 110° on the left side of the listener position and the left and right ears of a dummy head, respectively, are referred to as B₁₁ and B₂₁. HRTFs between a speaker located between 90° and 110° on the right side of the listener position and the left and right ears of the dummy head, respectively, are referred to as B₁₂ and B₂₂.

When the listener hears an output signal of the binaural synthesized filter through a headphone, the listener perceives that a sound image is positioned between 90° and 110° on each of the left and right sides of the listener position. Binaural synthesis provides best performance when a sound is reproduced through a headphone. On the other hand, when the sound is reproduced through two speakers, crosstalk occurs between the two speakers and the two ears of the listener, thereby degrading a sense of localization of the sound. In other words, although a sound of the left channel should only be heard in the left ear and a sound of the right channel should only be heard in the right ear, the left channel sound is heard by the right ear and the right channel sound is heard by the left ear due to the crosstalk between the two channels. Thus, the sense of localization is degraded, such that the sound image is not positioned at a desired location with respect to the listener position.

Hence, the crosstalk cancellation filter (C₁₁, C₁₂, C₂₁, and C₂₂) is designed so as to remove this crosstalk phenomenon. First, HRTFs between the listener position and two speakers are measured to design the crosstalk cancellation filter (C₁₁, C₁₂, C₂₁, and C₂₂). HRTFs between a speaker located at a specific position on the left side of the listener position (e.g., between 90° and 100° with respect to the front center of the listener position) and the left and right ears of a dummy head are, respectively, referred to as H₁₁ and H₂₁, and HRTFs between a speaker located at the specific position on the right side of the listener position (e.g., between 90° and 100° with respect to the front center of the listener position) and the left and right ears of the dummy head are, respectively, referred to as H₁₂ and H₂₂. In this case, a crosstalk cancellation filter matrix C(z) is designed by inversing the second matrix of the HRTFs H₁₁, H₁₂, H₂₁ and H₂₂ as in Equation 1:

$$[ \begin{matrix}{C}_{11} ( z ) & {C}_{12} ( z ) \\ {C}_{21} ( z ) & {C}_{22} ( z )\end{matrix} ] = {[ \begin{matrix}{H}_{11} ( z ) & {H}_{12} ( z ) \\ {H}_{21} ( z ) & {H}_{22} ( z )\end{matrix} ]}^{- 1} \qquad ( 1 )$$

The binaural synthesis filter matrix (B₁₁, B₁₂, B₂₁, and B₂₂) localizes virtual speakers at positions of the left and right surround speakers (e.g., between 90° and 100° with respect to the front center of the listener position). The crosstalk cancellation filter matrix C(z) removes the crosstalk between two speakers and the left and right ears. Hence, a matrix K(z) used by the virtual sound source generation unit is calculated by multiplying the binaural synthesis filter matrix (B₁₁, B₁₂, B₂₁, and B₂₂) and the crosstalk cancellation filter matrix C(z) as in Equation 2:

$$[ \begin{matrix}{K}_{11} ( Z ) & {K}_{12} ( Z ) \\ {K}_{21} ( Z ) & {K}_{22} ( Z )\end{matrix} ] = [ \begin{matrix}{C}_{11} ( z ) & {C}_{12} ( z ) \\ {C}_{21} ( z ) & {C}_{22} ( z )\end{matrix} ] [ \begin{matrix}{B}_{11} ( z ) & {B}_{12} ( z ) \\ {B}_{21} ( z ) & {B}_{22} ( z )\end{matrix} ] \qquad ( 2 )$$

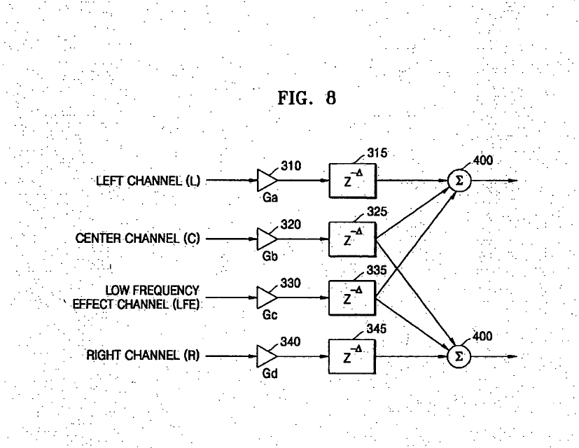

FIG. 8 is a block diagram illustrating the output controller 300 (see FIG. 2) according to an embodiment of the present general inventive concept. The output controller includes gain units 310, 320, 330, and 340 and delay units 315, 325, 335, and 345.

A gain of the left channel audio input signal L is changed while passing through the gain unit (Ga) 310. The left channel audio input signal L is then delayed by the delay unit Z^{-Δ} 315.

A gain of the center channel audio input signal C is changed while passing through the gain unit (Gb) 320. The center channel audio input signal C is then delayed by the delay unit Z^{-Δ} 325.

A gain of the LFE channel audio input signal LFE is changed while passing through the gain unit (Gc) 330. The LFE channel audio input signal LFE is then delayed by the delay unit Z−Δ 335.

A gain of the right channel audio input signal R is changed while passing through the gain unit (Gd) 340. The right channel audio input signal R is then delayed by the delay unit Z^{-Δ} 345.

While passing through the virtual surround filter 200 (see FIG. 2), the gains and delays of the left and right surround channel audio input signals Ls and Rs are also changed. In other words, the change of gains and delays of the left and right surround channel audio input signals Ls and Rs depends upon the components of the virtual surround filter 200 (see FIG. 2). Accordingly, the gains and delays applied by the gain units 310, 320, 330, 340, and delay units 315, 325, 335, and 345 to the left, center, LFE, and right channel audio input signals L, C, LFE, and R are adjusted based on the characteristics of the virtual surround filter 200 (see FIG. 2).

Values Ga, Gb, Gc, and Gd of the gain units, which relate to an output gain, are determined through a comparison between an RMS power of input and output signals of the virtual surround filter 200 (see FIG. 2). A time delay value Z^{-Δ} is obtained through an impulse response of or a group delay of the virtual surround filter 200 (see FIG. 2).

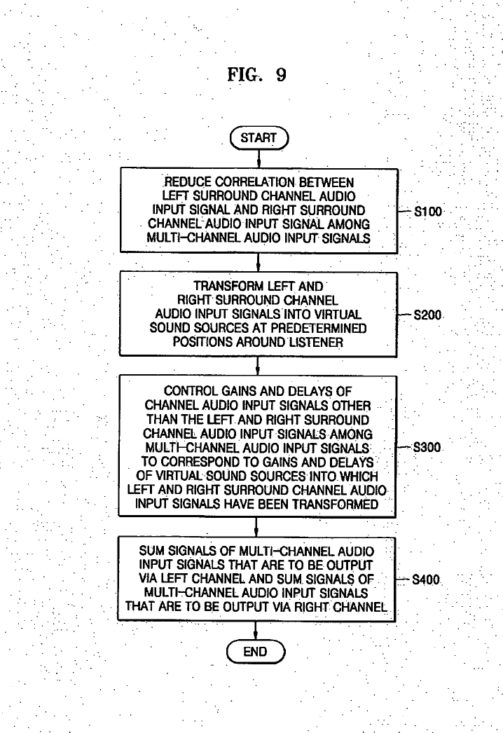

FIG. 9 is a flowchart illustrating a method of processing multi-channel audio input signals to produce two channel output signals. First, in operation S100, a correlation between a left surround channel audio input signal Ls and a right surround channel audio input signal Rs among the multi-channel audio input signals is reduced. The reduction of the correlation is described below in greater detail.

In operation S200, the left and right surround channel audio input signals Ls and Rs having the reduced correlation are transformed into virtual sound sources at predetermined positions around a listener position, namely, a left surround and a right surround.

Then, in operation S300, gains and delays of channel audio input signals other than the left and right surround channel audio input signals Ls and Rs, namely, left, center, LFE, and right channel audio input signals L, C, LFE, and R, are controlled to correspond to the gains and delays of the virtual sound sources into which the left and right surround channel audio input signals Ls and Rs have been transformed in the operation S200.

In operation S400, signals to be output via a left channel of the multi-channel audio input signals, on which the operations S200 and S300 have been performed, are added together (i.e., summed), and signals to be output via a right channel of the multi-channel audio input signals, on which the operations S200 and S300 have been performed, are added together. The signals of the left and right channels can then be output by left and right speakers, respectively.

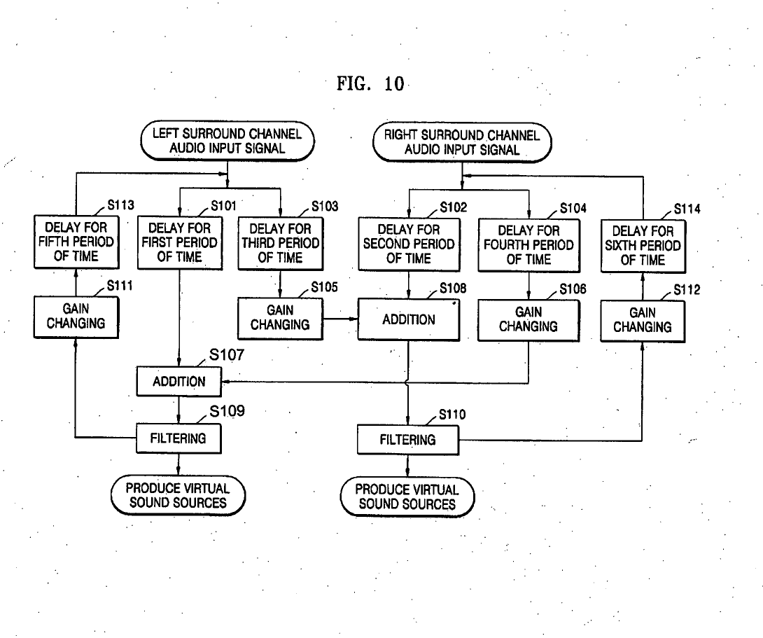

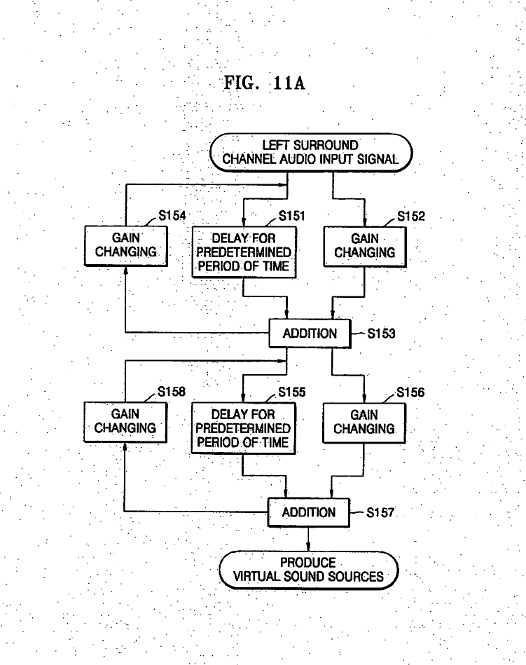

FIG. 10 is a flowchart illustrating a method of reducing a correlation between a left surround channel audio input signal Ls and a right surround channel audio input signal Rs, according to an embodiment of the present general inventive concept. First, in operation S101, the left surround channel audio input signal Ls is delayed for a first period of time. In operation S102, the right surround channel audio input signal Rs is delayed for a second period of time.

In operation S103, the left surround channel audio input signal Ls is delayed for a third period of time. In operation S104, the right surround channel audio input signal Rs is delayed for a fourth period of time.

In operation S105, a gain of the left surround channel audio input signal Ls delayed in the operation S103 is changed. In operation S106, a gain of the right surround channel audio input signal Rs delayed in the operation S104 is changed.

In operation S107, the left surround channel audio input signal Ls delayed in the operation S101 is added to the right surround channel audio input signal Rs having the gain changed in the operation S106. In operation S108, the right surround channel audio input signal Rs delayed in the operation S102 is added to a signal obtained by changing the gain of the left surround channel audio input signal Ls in the operation S105.

In operation S109, a high-band component of a signal obtained by the addition in the operation S107 is filtered out. In operation S110, a high-band component of a signal added in the operation S108 is filtered out.

In operation S111, a gain of a signal obtained by the filtering in the operation S109 is changed. In operation S112, a gain of a signal obtained by the filtering in the operation S110 is changed.

A signal obtained by the changing of the gain in the operation S11 is then delayed for a fifth period of time in operation S113, and the delayed signal is fed back to the operations S101 and S103. A signal obtained by the changing of the gain in the operation S112 is then delayed for a sixth period of time in operation S114, and the delayed signal is fed back to the operations S102 and S104.

In the present embodiment, the first, second, third, fourth, fifth, and sixth periods of time are different from each other.

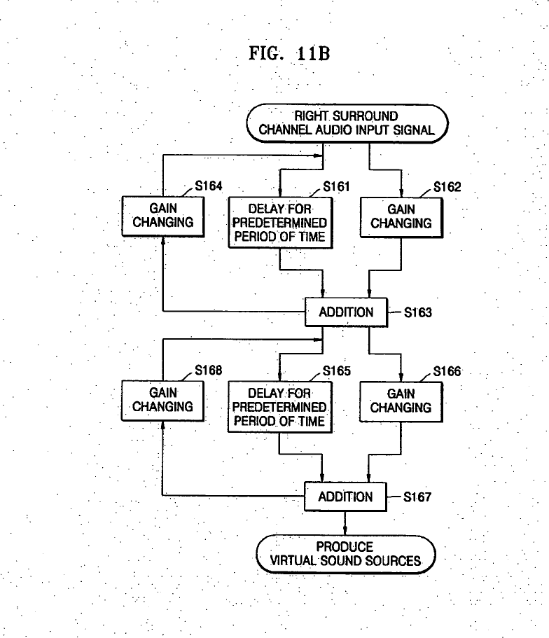

FIG. 11A is a flowchart illustrating a method of group-delaying a specific frequency component of the left surround channel audio input signal Ls according to another embodiment of the present general inventive concept. FIG. 11B is a flowchart illustrating a method of group-delaying a specific frequency component of the right surround channel audio input signal Rs according to another embodiment of the present general inventive concept.

Referring to FIG. 11A, in operation S151, the left surround channel audio input signal Ls is delayed for a first predetermined period of time.

In operation S152, a gain of the left surround channel audio input signal Ls is changed.

In operation S153, signals obtained in the operations S151 and S152 are added together. A gain of the signal obtained by the addition in the operation S153 is then changed in operation S154, and the signal obtained in the operation S154 is fed back to the operation S151.

In operation S155, the signal obtained by the addition in the operation S153 is delayed for a second predetermined period of time.

In operation S156, a gain of the signal obtained by the addition in the operation S153 is changed.

In operation S157, signals obtained in the operations S155 and S156 are added together. A sum of the signals is output as a virtual sound source. A gain of the signal obtained by the addition in the operation S157 is then changed in operation S158, and the signal obtained in the operation S158 is fed back to the operation S155.

The method illustrated in FIG. 11B is similar to the method illustrated in FIG. 11A with respect to the right surround channel audio input signal Rs.

Referring to FIG. 11B, in operation S161, the right surround channel audio input signal Rs is delayed for a first predetermined period of time.

In operation S162, a gain of the right surround channel audio input signal Rs is changed.

In operation S163, signals obtained in the operations S161 and S162 are added together. A gain of the signal obtained by the addition in the operation S163 is then changed in operation S164, and a signal obtained in the operation S164 is fed back to the operation S161.

In operation S165, the signal obtained by the addition in the operation S163 is delayed for a second predetermined period of time.

In operation S166, a gain of the signal obtained by the addition in the operation S163 is then changed.

In operation S167, signals obtained in the operations S165 and S166 are added together. A sum of the signals is output as a virtual sound source. A gain of a signal obtained by the addition in the operation S167 is then changed in operation S168, and the signal obtained in the operation S168 is fed back to the operation S165.

The first and second predetermined periods of time in the operations S151, S155, S161, and S165 of FIGS. 11A and 11B are set to be different from each other. A delay time in the operation S151 is longer than a delay time in the operation S155, and a delay time in the operation S161 is longer than a delay time in the operation S165. Alternatively, the delay time in the operation S155 may be set to be longer than the delay time in the operation S151, and the delay time in the operation S165 may be set to be longer than the delay time in the operation S161.

Gain changes in the above operations are typically identical, but in some cases, may be set to be different from each other.

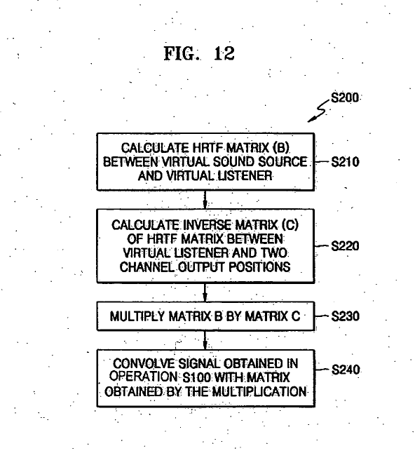

FIG. 12 is a flowchart illustrating in detail the operation S200 (see FIG. 9) of transforming the left and right surround channel audio input signals Ls and Rs into the virtual sound sources. First, in operation S210, a first HRTF matrix B between the virtual sound source and the virtual listener at the listener position is calculated.

In operation S220, a second HRTF matrix between the virtual listener and 2 channel output locations (i.e., a left speaker and a right speaker) is obtained, and an inverse matrix C of the second HRTF matrix is calculated.

In operation S230, the first HRTF matrix B calculated in the operation S210 is multiplied by the inverse matrix C calculated in the operation S220 to obtain a product matrix.

In operation S240, a signal obtained in the operation S100 (see FIG. 9) is convolved with the product matrix obtained in the operation S230.

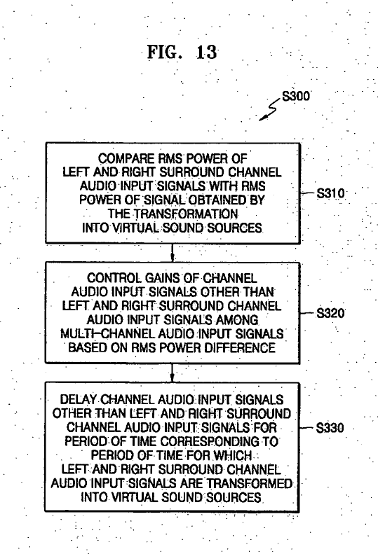

FIG. 13 is a flowchart illustrating in detail the operation S300 (see FIG. 9) of controlling the gains and delays of channel audio input signals other than the left and right surround channel audio input signals Ls and Rs. First, in operation S310, an RMS power of the left and right surround channel audio input signals Ls and Rs is compared with an RMS power of a signal obtained by the transformation in the operation S200 (see FIG. 9).

In operation S320, the gains of the channel audio input signals other than the left and right surround channel audio input signals Ls and Rs, namely, the left, center, LFE, and right channel audio input signals L, C, LFE, and R, are controlled based on a difference between the RMS powers obtained in the operation S310.

In operation S330, the left, center, LFE, and right channel audio input signals L, C, LFE, and R are delayed for a period of time that corresponds to the period of time during which the left and right surround channel audio input signals Ls and Rs are transformed into the virtual sound sources.

The present general inventive concept may be embodied in hardware, software, or a combination thereof. For example, the present general inventive concept may be embodied by a computer running a program from a computer-readable medium, including but not limited to storage media such as magnetic storage media (ROMs, RAMs, floppy disks, magnetic tapes, etc.), optically readable media (CD-ROMs, DVDs, etc.), and carrier waves (transmission over the internet). The present general inventive concept may be embodied as a computer-readable medium having a computer-readable program code to cause a number of computer systems connected via a network to effect distributed processing.

As described above, in an apparatus and method of reproducing multi-channel audio input signals through two channels according to various embodiments of the present general inventive concept, even when the multi-channel audio input signals are reproduced through 2 channels, a surround effect provided by a multi-channel speaker system can be obtained.

In addition, since left and right surround channel audio input signals are transformed into virtual speakers at a left rear and a right rear of a listener position, the listener can perceive a surround effect.

Furthermore, even when a correlation between the left and right surround channel audio input signals is high, a localization of a sound can be improved, and a presence is formed. Thus, an enhanced surround sound is provided to the listener.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to process m-channel audio input signals to produce n channel output signals, n being less than m, the apparatus comprising:
a first filter unit to reduce a correlation between at least two channel audio input signals among the m-channel audio input signals;
a virtual sound source generation unit to transform the at least two channel audio input signals output by the first filter unit into virtual sound sources at predetermined positions around a listener position; and
an output controller to control gains and delays channel audio input signals other than the at least two channel audio input signals among the m-channel audio input signals based on gains and delays of the at least two-channel audio input signal output from the virtual sound source generation unit.

2. The apparatus of claim 1, wherein the first filter unit comprises a plurality of delay units, gain units, and filter units so that the correlation is reduced.

3. The apparatus of claim 2, wherein each of the plurality of delay units induces a different delay.

4. The apparatus of claim 1, further comprising:
an addition unit to add first signals output from the virtual sound source generation unit and the output controller to produce a first channel signal and to add second signals output by the virtual sound source generation unit and the output controller to produce a second channel signal.

5. The apparatus of claim 1, wherein the first filter unit comprises:
a first delay unit to delay a first channel audio input signal of the at least two channel audio input signals for a first period of time; and
a second delay unit to delay a second channel audio input signal of the at least two channel audio input signals for a second period of time.

6. The apparatus of claim 5, wherein the first filter unit further comprises:
a third delay unit to delay the first channel audio input signal of the at least two channel audio input signals for a third period of time;
a fourth delay unit to delay the second channel audio input signal of the at least two channel audio input signals for a fourth period of time;
a first gain unit to change a gain of an output of the third delay unit;
a second gain unit to change a gain of an output of the fourth delay unit;
a first adder to add an output of the first delay unit to an output of the second gain unit; and
a second adder to add an output of the second delay unit to an output of the first gain unit.

7. The apparatus of claim 6, wherein the first filter unit further comprises:
a first filter to filter an output of the first adder;
a second filter to filter an output of the second adder;
a fifth delay unit to delay an output of the first filter for a fifth period of time;
a sixth delay unit to delay an output of the second filter for a sixth period of time;
a third gain unit to change a gain of an output of the fifth delay unit;
a fourth gain unit to change a gain of an output of the sixth delay unit;
a third adder to add the first channel audio input signal to an output of the third gain unit; and
a fourth adder to add the second channel audio input signal to an output of the fourth gain unit.

8. The apparatus of claim 7, wherein the first, second, third, fourth, fifth, and sixth periods of time are different.

9. The apparatus of claim 5, wherein the virtual sound source generation unit comprises:
a transformation unit to transform the first and second channel audio input signals output from the first filter unit into virtual sound sources at the predetermined positions around the listener position; and
a second filter unit comprising a crosstalk cancellation unit to cancel crosstalk between the virtual sound sources.

10. The apparatus of claim 9, wherein the second filter unit comprises:
a binaural synthesis filter to provide a first head related transfer function matrix between the virtual sound sources and a virtual listener at the listener position; and
a crosstalk cancellation filter to provide an inverse matrix of a second head related transfer function matrix between the virtual listener and output positions of the at least two channels.

11. The apparatus of claim 1, wherein the output controller comprises:
a gain unit to change gains of the channel audio input signals other than the at least two channel audio input signals; and
a delay unit to delay the channel audio input signals other than the at least two channel audio input signals for a predetermined period of time.

12. The apparatus of claim 11, wherein a gain change of the gain unit is determined by comparing signals output from the virtual sound source generation unit with the at least two channel audio input signals.

13. The apparatus of claim 12, wherein the gain change of the gain unit is determined by comparing a root mean square (RMS) power of the signals output from the virtual sound source generation unit with an RMS power of the at least two channel audio input signals.

14. The apparatus of claim 11, wherein the predetermined period of time is determined based on a group delay induced by the first filter unit.

15. The apparatus of claim 11, wherein the first filter unit forms a presence.

16. An apparatus to process m-channel audio input signals to produce n channel output signals, n being less than m, the apparatus comprising:
a first filter unit to induce a group-delay in a specific frequency component of at least two-channel audio input signals among the m-channel audio input signals;
a virtual sound source generation unit to transform the at least two channel audio input signals output from the first filter unit into virtual sound sources at predetermined positions around a listener position; and
an output controller to control gains and delays of channel audio input signals other than the at least two channel audio input signals among the m-channel audio input signals based on gains and delays of the at least two-channel audio input signals output by the virtual sound source generation unit.

17. The apparatus of claim 16, wherein the first filter unit comprises a plurality of delay units and gain units.

18. The apparatus of claim 17, wherein each of the plurality of delay units induces a different delay.

19. The apparatus of claim 16, further comprising:
an addition unit to add first signals output from the virtual sound source generation unit and the output controller to produce a first channel signal and to add second signals output from the virtual sound source generation unit and the output controller to produce a second channel signal.

20. The apparatus of claim 19, wherein the first filter unit comprises a plurality of full band filters, and a predetermined number of the plurality of full band filters are dependently connected to each of the at least two-channel audio input signals which correspond to first and second channel audio input signals received on first and second channels.

21. The apparatus of claim 20, wherein each of the plurality of full band filters comprises:
a delay unit to delay an audio input signal for a predetermined period of time;
a first gain unit to change a gain of the audio input signal;
a first adder to add an output of the first gain unit to an output of the delay unit;
a second gain unit to change a gain of an output of the first adder; and
a second adder to add an output of the second gain unit to the audio input signal.

22. The apparatus of claim 21, wherein the predetermined periods of time in the delay units of each of the full band filters connected to each of the first and second channels are different.

23. The apparatus of claim 22, wherein when the predetermined periods of time in the plurality of delay units of the full band filters dependently connected to the first channel are increased, the predetermined periods of time in the plurality of delay units of the full band filters dependently connected to the second channel are also increased, and when the predetermined periods of time in the plurality of delay units of the full band filters dependently connected to the first channel are decreased, the predetermined periods of time in the plurality of delay units of the full band filters dependently connected to the second channel are also decreased.

24. The apparatus of claim 21, wherein the first and second gain units have identical gains with different signs.

25. The apparatus of claim 20, wherein the virtual sound source generation unit comprises:
a transformation unit to transform the first and second channel audio input signals output from the first filter unit into the virtual sound sources at the predetermined positions around the listener position; and
a second filter unit comprising a crosstalk cancellation unit to cancel crosstalk between the virtual sound sources.

26. The apparatus of claim 25, wherein the second filter unit comprises:
a binaural synthesis filter to provide a first head related transfer function matrix between the virtual sound sources and a virtual listener at the listener position; and
a crosstalk cancellation filter to provide an inverse matrix of a second head related transfer function matrix between the virtual listener and positions of the at least two channels.

27. The apparatus of claim 19, wherein the output controller comprises:
a gain unit to change gains of the channel audio input signals other than the at least two channel audio input signals; and
a delay unit to delay the channel audio input signals other than the at least two channel audio input signals for a predetermined period of time.

28. The apparatus of claim 27, wherein a gain change of the gain unit is determined by comparing signals output from the virtual sound source generation unit with the at least two channel audio input signals.

29. The apparatus of claim 28, wherein the gain change of the gain unit is determined by comparing a root mean square (RMS) power of the signals output from the virtual sound source generation unit with an RMS power of the at least two channel audio input signals.

30. The apparatus of claim 27, wherein the predetermined period of time is determined based on the group delay induced by the first filter unit.

31. The apparatus of claim 27, wherein the first filter unit forms a presence.

32. A method of processing m-channel audio input signals to produce n channel output signals, n being less than m, the method comprising:
reducing a correlation between at least two channel audio input signals among the m-channel audio input signals;
transforming the at least two channel audio input signals into virtual sound sources at predetermined positions around a listener position; and
controlling gains and delays of channel audio input signals other than the at least two channel audio input signals among the m-channel audio input signals based on gains and delays of the at least two channel audio input signal that are transformed into the virtual sound sources.

33. The method of claim 32, wherein the reducing of the correlation further comprises:
performing a first delaying operation to delay the at least two channel audio input signals each for a predetermined period of time;
performing a first gain changing operation to change gains of the delayed at least two channel audio input signals; and
performing a first filtering operation to filter the at least two channel audio input signals.

34. The method of claim 33, wherein the each of the predetermined period times by which the at least two channel audio input signals is delayed are different from each other.

35. The method of claim 32, further comprising:
adding first signals of the m-channel audio input signals obtained by the transformation and the gain and delay controlling to produce a first channel and adding second signals of the m-channel audio input signals obtained by the transformation and the gain and delay controlling to produce a second channel.

36. The method of claim 35, wherein the reducing of the correlation comprises:
performing a first delaying operation to delay a first channel audio input signal of the at least two channel audio input signals for a first period of time; and
performing a second delaying operation to delay a second channel audio input signal of the at least two channel audio input signals for a second period of time.

37. The method of claim 36, wherein the reducing of the correlation further comprises:
performing a third delaying operation to delay the first channel audio input signal of the at least two channel audio input signals for a third period of time;
performing a fourth delaying operation to delay the second channel audio input signal of the at least two channel audio input signals for a fourth period of time;
performing a first adding operation to add a signal delayed for the first period of time to a signal delayed for the fourth period of time; and
performing a second adding operation to add a signal delayed for the second period of time to a signal delayed for the third period of time.

38. The method of claim 37, wherein the reducing of the correlation further comprises:
performing a first filtering operation to filter a signal obtained in the first adding operation of the signal delayed for the first period of time to the signal delayed for the fourth period of time;
performing a second filtering operation to filter a signal obtained in the second adding operation of the signal delayed for the second period of time to the signal delayed for the third period of time;
performing a first gain changing operation to change a gain of a signal obtained in the second filtering operation, and delaying the signal obtained by the first gain changing operation for a fifth period of time;
performing a second gain changing operation to change a gain of a signal obtained in the second filtering operation, and delaying the signal obtained by the second gain changing operation for a sixth period of time;
performing a third adding operation to add a signal delayed for the fifth period of time to the first channel audio input signal; and
performing a fourth adding operation to add a signal delayed for the sixth period of time to the second channel audio input signal.

39. The method of claim 38, wherein the first, second, third, fourth, fifth, and sixth periods of time are different from each other.

40. The method of claim 36, wherein the transforming of the at least two channel audio input signals comprises:
calculating a first head related transfer function matrix (B) between the virtual sound sources and a virtual listener at the listener position;
calculating an inverse matrix (C) of a second head related transfer function matrix between the virtual listener and positions of the at least two channels;
multiplying the first head related transfer function matrix (B) by the inverse matrix (C) to calculate a product matrix; and
convolving the first and second channel audio input signals between which the correlation has been reduced with the product matrix.

41. The method of claim 32, wherein the controlling of the gains and the delays comprises:
controlling gains of the channel audio input signals other than the at least two channel audio input signals based on a determination of gains of the at least two channel audio input signals obtained by the transformation into the virtual sound sources; and
delaying the channel audio input signals other than the at least two channel audio input signals based on a period of time required to transform the at least two channel audio inputs signals into the virtual sound sources.

42. The method of claim 41, wherein the gains of the channel audio input signals other than the at least two channel audio input signals are controlled based on a result of a comparison between a root mean square (RMS) power of the at least two channel audio input signals obtained by the transformation into the virtual sound sources and an RMS power of the at least two channel audio input signals before the transformation thereof into the virtual sound sources.

43. A method of processing m-channel audio input signals to produce n channel output signals, n being less than m, the method comprising:
group-delaying a specific frequency component of at least two-channel audio input signals among the m-channel audio input signals;
transforming the at least two channel audio input signals into virtual sound sources at predetermined positions around a listener position; and
controlling gains and delays of channel audio input signals other than the at least two channel audio input signals among the m-channel audio input signals based on gains and delays of the at least two channel audio input signals transformed into the virtual sound sources.

44. The method of claim 43, wherein the group-delaying of the specific frequency component further comprises:
performing a first delaying operation to delay the at least two channel audio input signals each for a corresponding predetermined period of time; and
performing a first gain changing operation to change gains of the delayed at least two channel audio input signals.

45. The method of claim 44, wherein the corresponding predetermined period time is different for each of the at least two channel audio input signals.

46. The method of claim 43, further comprising:
adding first signals of the m-channel audio input signals obtained by the transformation and the gain and delay controlling to produce a first channel and adding second signals of the m-channel audio input signals obtained by the transformation and the gain and delay controlling to produce a second channel.

47. The method of claim 46, wherein the group delaying of the specific frequency component comprises:
passing a first channel audio input signal of the at least two channel audio input signals through full band filters; and
passing a second channel audio input signal of the at least two channel audio input signals through full band filters,
wherein the full band filters through which each of the first and second audio input signals pass includes a predetermined number of full band filters dependently connected to each of the at least two channels, which correspond to first and second channels.

48. The method of claim 47, wherein:
the passing of the first channel audio input signal comprises:
performing a first delaying operation to delay the first channel audio input signal for a predetermined period of time using a current first full band filter,
performing a first adding operation to add the delayed first channel audio input signal to a signal obtained by changing the gain of the first channel audio input signal,
using a signal obtained by the first adding operation as an input of a next first full band filter, and
performing a first gain changing operation to change a gain of the signal obtained by the first adding operation; and
the passing of the second channel audio input signal comprises:
performing a second delaying operation to delay the second channel audio input signal for a predetermined period of time using a current second full band filter,
performing a second adding operation to add the delayed second channel audio input signal to a signal obtained by changing the gain of the second channel audio input signal,
using a signal obtained by the second adding operation addition as an input of a second next full band filter, and
performing a second gain changing operation to change a gain of the signal obtained by the second adding operation.

49. The method of claim 48, wherein the predetermined periods of time for which the first and second channel audio input signals are delayed are different from each other.

50. The method of claim 49, wherein the predetermined periods of time for which the first and second channel audio input signals are delayed both increase or both decrease.

51. The method of claim 46, wherein the transforming of the at least two channel audio input signals comprises:
calculating a first head related transfer function matrix (B) between the virtual sound sources and a virtual listener at the listener position;
calculating an inverse matrix (C) of a second head related transfer function matrix between the virtual listener and positions of the at least two channels;
multiplying the first head related transfer function matrix (B) by the inverse matrix (C) to determine a product matrix; and
convolving the at least two channel audio input signals between which the correlation has been reduced with the product matrix.

52. The method of claim 46, wherein the controlling of the gains and the delays comprises:
controlling gains of the channel audio input signals other than the at least two channel audio input signals based on a determination of a gain of the at least two channel audio input signals obtained by the transformation into the virtual sound sources; and
delaying the channel audio input signals other than the at least two channel audio input signals based on a period of time required to transform the at least two channel audio inputs signals into the virtual sound sources.

53. The method of claim 52, wherein the gains of the channel audio input signals other than the at least two channel audio input signals are controlled based on a result of a comparison between a root mean square (RMS) power of the at least two channel audio input signals obtained by the transformation into the virtual sound sources and an RMS power of the at least two channel audio input signals before the transformation thereof into the virtual sound sources.

54. A computer readable medium containing executable code to process m-channel audio input signals to produce n channel output signals, n being less than m, the medium comprising:
executable code to reduce a correlation between at least two channel audio input signals among the m-channel audio input signals;
executable code to transform the at least two channel audio input signals into virtual sound sources at predetermined positions around a listener position; and
executable code to control gains and delays of channel audio input signals other than the at least two channel audio input signals among the m-channel audio input signals based on gains and delays of the at least two channel audio input signal that are transformed into the virtual sound sources.

55. The medium of claim 54, wherein the executable code to reduce the correlation comprises:
executable code to perform a first delaying operation to delay the at least two channel audio input signals each for a predetermined period of time;
executable code to perform a first gain changing operation to change gains of the delayed at least two channel audio input signals; and
executable code to perform a first filtering operation to filter the at least two channel audio input signals.

56. The medium of claim 55, wherein the each predetermined period times by which the at least two channel audio input signals is delayed are different from each other.

57. The medium of claim 54, further comprising:
executable code to add first signals of the m-channel audio input signals obtained by the transformation and the gain and delay controlling to produce a first channel and to add second signals of the m-channel audio input signals obtained by the transformation and the gain and delay controlling to produce a second channel.

58. The medium of claim 57, wherein the executable to reduce the correlation comprises:
executable code to perform a first delaying operation to delay a first channel audio input signal of the at least two channel audio input signals for a first period of time; and
executable code to perform a second delaying operation to delay a second channel audio input signal of the at least two channel audio input signals for a second period of time.

59. The medium of claim 58, wherein the executable code to reduce the correlation further comprises:
executable code to perform a third delaying operation to delay the first channel audio input signal of the at least two channel audio input signals for a third period of time;
executable code to perform a fourth delaying operation to delay the second channel audio input signal of the at least two channel audio input signals for a fourth period of time;
executable code to perform a first adding operation to add a signal delayed for the first period of time to a signal delayed for the fourth period of time; and
executable code to perform a second adding operation to add a signal delayed for the second period of time to a signal delayed for the third period of time.

60. The medium of claim 59, wherein the executable code to reduce the correlation further comprises:
executable code to perform a first filtering operation to filter a signal obtained in the first adding operation of the signal delayed for the first period of time to the signal delayed for the fourth period of time;
executable code to perform a second filtering operation to filter a signal obtained in the second adding operation of the signal delayed for the second period of time to the signal delayed for the third period of time;
executable code to perform a first gain changing operation to change a gain of a signal obtained in the first filtering operation, and delaying the signal obtained by the first gain changing operation for a fifth period of time;
executable code to perform a second gain changing operation to change a gain of a signal obtained in the second filtering operation, and delaying the signal obtained by the second gain changing operation for a sixth period of time;
executable code to perform a third adding operation to add a signal delayed for the fifth period of time to the first channel audio input signal; and
executable code to perform a fourth adding operation to add a signal delayed for the sixth period of time to the second channel audio input signal.

61. The medium of claim 60, wherein the first, second, third, fourth, fifth, and sixth periods of time are different from each other.

62. The medium of claim 58, wherein the executable code to transform the at least two channel audio input signals comprises:
executable code to calculate a first head related transfer function matrix (B) between the virtual sound sources and a virtual listener;
executable code to calculate an inverse matrix (C) of a second head related transfer function matrix between the virtual listener and positions of the at least two channels;
executable code to multiply the first head related transfer function matrix (B) by the inverse matrix (C) to calculate a product matrix; and
executable code to convolve the first and second channel audio input signals between which the correlation has been reduced with the product matrix.

63. The medium of claim 54, wherein the executable code to control the gains and the delays comprises:
executable code to control gains of the channel audio input signals other than the at least two channel audio input signals based on a determination of a gain of the at least two channel audio input signals obtained by the transformation into the virtual sound sources; and
executable code to delay the channel audio input signals other than the at least two channel audio input signals based on a period of time required to transform the at least two channel audio inputs signals into the virtual sound sources.

64. The medium of claim 63, wherein the gains of the channel audio input signals other than the at least two channel audio input signals are controlled based on a result of a comparison between a root mean square (RMS) power of the at least two channel audio input signals obtained by the transformation into the virtual sound sources and an RMS power of the at least two channel audio input signals before the transformation thereof into the virtual sound sources.

65. A computer readable medium containing executable code to process m-channel audio input signals to produce n channel output signals, n being less than m, the medium comprising:
executable code to induce a group-delay in a specific frequency component of at least two-channel audio input signals among the m-channel audio input signals;
executable code to transform the at least two channel audio input signals into virtual sound sources at predetermined positions around a listener position; and
executable code to control gains and delays of channel audio input signals other than the at least two channel audio input signals among the m-channel audio input signals based on gains and delays of the at least two channel audio input signals transformed into the virtual sound sources.

66. An apparatus to process m-channel audio input signals to produce n channel output signals, n being less than m, the apparatus comprising:
a first filter unit to reproduce a sound field;
a virtual sound source generation unit to transform at least two channel audio input signals that define the reproduced sound field output by the first filter unit into virtual sound sources at predetermined positions around a listener position; and
an output controller to control gains and delays of channel audio input signals other than the at least two channel audio input signals among the m-channel audio input signals based on gains and delays of the at least two-channel audio input signal output from the virtual sound source generation unit

67. The apparatus of claim 66, wherein the first filter unit comprises a plurality of delay units, gain units, and filter units.

68. The apparatus of claim 67, wherein times for delay of each of the plurality of delay units is different.

69. The apparatus of claim 66, further comprising:
an addition unit to add first signals output from the virtual sound source generation unit and the output controller to produce a first channel signal and adding second signals output by the virtual sound source generation unit and the output controller to produce a second channel signal.

70. The apparatus of claim 66, wherein the first filter unit comprises:
a first delay unit to delay a first channel audio input signal of the at least two channel audio input signals for a first period of time; and
a second delay unit to delay a second channel audio input signal of the at least two channel audio input signals for a second period of time.

71. The apparatus of claim 70, wherein the first filter unit further comprises:
a third delay unit to delay the first channel audio input signal of the at least two channel audio input signals for a third period of time;
a fourth delay unit to delay the second channel audio input signal of the at least two channel audio input signals for a fourth period of time;
a first gain unit to change a gain of an output of the third delay unit;
a second gain unit to change a gain of an output of the fourth delay unit;
a first adder to add an output of the first delay unit to an output of the second gain unit; and
a second adder to add an output of the second delay unit to an output of the first gain unit.

72. The apparatus of claim 71, wherein the first filter unit further comprises:
a first filter to filter an output of the first adder;
a second filter to filter an output of the second adder;
a fifth delay unit to delay an output of the first filter for a fifth period of time;
a sixth delay unit to delay an output of the second filter for a sixth period of time;
a third gain unit to change a gain of an output of the fifth delay unit;
a fourth gain unit to change a gain of an output of the sixth delay unit;
a third adder to add the first channel audio input signal to an output of the third gain unit; and
a fourth adder to add the second channel audio input signal to an output of the fourth gain unit.

73. The apparatus of claim 72, wherein the first, second, third, fourth, fifth, and sixth periods of time are different from each other.

74. The apparatus of claim 70, wherein the virtual sound source generation unit comprises:
a transformation unit to transform the first and second channel audio input signals output from the first filter unit into the virtual sound sources at the predetermined positions around the listener position; and
a second filter unit comprising a crosstalk cancellation unit to cancel crosstalk between the virtual sound sources.

75. The apparatus of claim 74, wherein the second filter unit comprises:
a binaural synthesis filter to provide a first head related transfer function matrix between the virtual sound sources and a virtual listener at the listener position; and
a crosstalk cancellation filter to provide an inverse matrix of a second head related transfer function matrix between the virtual listener and output positions of the at least two channels.

76. The apparatus of claim 66, wherein the output controller comprises:
a gain unit to change the gains of the channel audio input signals other than the at least two channel audio input signals; and
a delay unit to delay the channel audio input signals other than the at least two channel audio input signals for a corresponding predetermined period of time.

77. The apparatus of claim 76, wherein a gain change applied by the gain unit is determined by comparing signals output from the virtual sound source generation unit with the at least two channel audio input signals.

78. The apparatus of claim 77, wherein the gain change applied by the gain unit is determined by comparing a root mean square (RMS) power of the signals output from the virtual sound source generation unit with an RMS power of the at least two channel audio input signals.

79. The apparatus of claim 76, wherein the corresponding predetermined period of time is determined based on a group delay induced by the first filter unit.

80. The apparatus of claim 76, wherein the first filter unit forms a presence.

81. An apparatus to process m-channel audio input signals to produce n channel output signals, n being less than m, the apparatus comprising:
a first filter unit to reproduce a sound field and to reduce a correlation between at least two channel audio input signals among the m-channel audio input signals;
a virtual sound source generation unit to transform the at least two channel audio input signals output by the first filter unit into virtual sound sources at predetermined positions around a listener position; and
an output controller to control gains and delays of channel audio input signals other than the at least two channel audio input signals among the m-channel audio input signals based on gains and delays of the at least two-channel audio input signal output from the virtual sound source generation unit.

82. The apparatus of claim 81, wherein the first filter unit comprises a plurality of delay units, gain units, and filter units.

83. The apparatus of claim 82, wherein a time delay induced by each of the plurality of delay units is different from each other.

84. The apparatus of claim 81, further comprising:
an addition unit to add first signals output from the virtual sound source generation unit and the output controller to produce a first channel signal and to add second signals output by the virtual sound source generation unit and the output controller to produce a second channel signal.

85. The apparatus of claim 81, wherein the first filter unit comprises:
a first delay unit to delay a first channel audio input signal of the at least two channel audio input signals for a first period of time; and
a second delay unit to delay a second channel audio input signal of the at least two channel audio input signals for a second period of time.

86. The apparatus of claim 85, wherein the first filter unit further comprises:
a third delay unit to delay the first channel audio input signal of the at least two channel audio input signals for a third period of time;
a fourth delay unit to delay the second channel audio input signal of the at least two channel audio input signals for a fourth period of time;
a first gain unit to change a gain of an output of the third delay unit;
a second gain unit to change a gain of an output of the fourth delay unit;
a first adder to add an output of the first delay unit to an output of the second gain unit; and
a second adder to add an output of the second delay unit to an output of the first gain unit.

87. The apparatus of claim 86, wherein the first filter unit further comprises:
a first filter to filter an output of the first adder;
a second filter to filter an output of the second adder;
a fifth delay unit to delay an output of the first filter for a fifth period of time;
a sixth delay unit to delay an output of the second filter for a sixth period of time;
a third gain unit to change a gain of an output of the fifth delay unit;
a fourth gain unit to change a gain of an output of the sixth delay unit;
a third adder to add the first channel audio input signal to an output of the third gain unit; and
a fourth adder to add the second channel audio input signal to an output of the fourth gain unit.

88. The apparatus of claim 87, wherein the first, second, third, fourth, fifth, and sixth periods of time are different from each other.

89. The apparatus of claim 85, wherein the virtual sound source generation unit comprises:
a transformation unit to transform the first and second channel audio input signals output from the first filter unit into the virtual sound sources at the predetermined positions around the listener position; and
a second filter unit comprising a crosstalk cancellation unit to cancel crosstalk between the virtual sound sources.

90. The apparatus of claim 89, wherein the second filter unit comprises:
a binaural synthesis filter to provide a first head related transfer function matrix between the virtual sound sources and a virtual listener at the listener position; and
a crosstalk cancellation filter to provide an inverse matrix of a second head related transfer function matrix between the virtual listener and output positions of the at least two channels.

91. The apparatus of claim 81, wherein the output controller comprises:
a gain unit to change gains of the channel audio input signals other than the at least two channel audio input signals; and
a delay unit to delay the channel audio input signals other than the at least two channel audio input signals for a predetermined period of time.

92. The apparatus of claim 91, wherein a gain change of the gain unit is determined by comparing signals output from the virtual sound source generation unit with the at least two channel audio input signals.

93. The apparatus of claim 92, wherein the gain change of the gain unit is determined by comparing a root mean square (RMS) power of the signals output from the virtual sound source generation unit with an RMS power of the at least two channel audio input signals.

94. The apparatus of claim 91, wherein the predetermined period of time is determined based on a group delay induce by the first filter unit.

95. The apparatus of claim 91, wherein the first filter unit forms a presence.

96. An apparatus to produce surround sound with a plurality of channel signals in a system having a predetermined number of speakers, the predetermined number of speakers being less than a number of the plurality of channel signals, the apparatus comprising:
a filter process unit to receive at least first and second channel signals of the plurality of channel signals having similar signal characteristics and to process the first and second channel signals differently such that the signal characteristics of the first and second channel signals are made different from each other; and
a virtual sound unit to produce at least first and second virtual sound sources at predetermined positions within a sound field from the first and second channel signals having the different signal characteristics.

97. The apparatus of claim 96, wherein the filter process unit comprises:
one or more first delay units to induce a first delay in the first channel signal; and
one or more second delay units to induce a second delay in the second channel signal, and the second delay is different from the first delay.

98. The apparatus of claim 97, wherein the filter process unit further comprises:
one or more first gain units to adjust a gain of the first channel signal;
one or more first filter units to filter the first channel signal;
one or more second gain units to adjust a gain of the second channel signal; and
one or more second filter units to filter the second channel signal.

99. The apparatus of claim 96, wherein the at least first and second channel signals comprise at least two of a right surround channel signal, a left surround channel signal, and a rear surround channel signal.

100. The apparatus of claim 96, wherein the predetermined positions are located between 90 and 100 degrees from a front center of a listening position within the sound space.

101. The apparatus of claim 96, wherein the virtual sound unit comprises a first head transfer unit to determine the first virtual sound source to output the first channel signal at a first position within the sound space and the second virtual sound source to output the second channel signal at a second position within the sound space.

102. The apparatus of claim 101, wherein the virtual sound unit further comprises a second head transfer unit to cancel crosstalk between the first channel signal and the second channel signal.

103. The apparatus of claim 96, wherein the filter process unit reduces a correlation between the at least first and second channel signals and to induce a group delay in the first and second channel signals.

104. An apparatus to process n channel signals to produce a surround sound effect in a speaker system having m speakers, m being less than n, the apparatus comprising:
a filter unit to induce different delays in at least two of the n channel signals; and
a virtual sound unit to receive the delayed at least two of the n channel signals and to localize the received at least two of the n channel signals at predetermined positions around a listener position; and
an output controller to control gains and delays of the n channel signals other than the at least two of the n channel signals according to gains and delays of the at least two of the n channel signals.

105. A method of producing surround sound with a plurality of channel signals in a system having a predetermined number of speakers, the predetermined number of speakers being less than a number of the plurality of channel signals, the method comprising:
receiving at least first and second channel signals of the plurality of channel signals having similar signal characteristics;
processing the first and second channel signals differently such that the signal characteristics of the first and second channel signals are made different from each other; and
producing at least first and second virtual sound sources at predetermined positions within a sound field from the first and second channel signals having different signal characteristics.

106. The method of claim 105, wherein the processing comprises:
inducing a first delay in the first channel signal; and
inducing a second delay in the second channel signal, and the second delay is different from the first delay.

107. The method of claim 106, wherein the processing further comprises:
adjusting a gain of the first channel signal;
filtering the first channel signal;
adjusting a gain of the second channel signal; and
filtering the second channel signal.

108. The method of claim 105, wherein the at least first and second channels comprises at least two of a right surround channel signal, a left surround channel signal, and a rear surround channel signal.

109. The method of claim 105, wherein the predetermined positions are located between 90 and 100 degrees from a front center of a listening position within the sound space.

110. The method of claim 105, wherein the producing of the first and second virtual sound sources comprises determining the first virtual sound source to output the first channel signal at a first position within the sound space and the second virtual sound source to output the second channel signal at a second position within the sound space.

111. The method of claim 110, wherein the producing of the first and second virtual sound sources further comprises canceling crosstalk between the first channel signal and the second channel signal.

112. The method of claim 105, wherein the processing comprises reducing a correlation between the first and second channel signals and inducing a group delay in the first and second channel signals.

113. A method of processing n channel signals to produce a surround sound effect in a speaker system having m signals, m being less than n, the method comprising:
inducing different delays in at least two of the n channel signals;
localizing the delayed at least two of the n channel signals at predetermined positions around a listener position; and
controlling gains and delays of the n channel signals other than the at least two of the n channel signals according to gains and delays of the at least two of the n channel signals.
